(19) United States
(12) Patent Application Publication
(10) Pub. No.: US 2026/0059432 A1
(43) Pub. Date: Feb. 26, 2026

(54) QUALITY ON DEMAND SYNCHRONIZATION

(71) Applicant: T-MOBILE INNOVATIONS LLC, Overland Park, KS (US)

(72) Inventors: Zenaida CANLAS-FACTORA, Renton, WA (US); Alex ABOGADO, Ashburn, VA (US)

(21) Appl. No.: 18/810,697

(22) Filed: Aug. 21, 2024

(51) Int. Cl. H04W 48/16; H04W 8/18

(52) U.S. Cl. CPC H04W 48/16; H04W 8/183

(57) ABSTRACT

Methods and systems provided herein provide for quality on demand synchronization between a policy control function (PCF) and network exposure function (NEF) during quality on demand processing. The method includes receiving, at a network exposure function (NEF), a termination message from a policy control function (PCF) or from an application function (AF) for terminating a subscription uplifting a quality of service (QoS) profile for a wireless device and processing the termination message. The method further includes deleting the subscription from the NEF upon processing the termination message.

### TECHNICAL BACKGROUND

As wireless networks evolve and grow, there are ongoing challenges in communicating data across different types of networks. For example, a wireless network may include one or more access nodes, such as base stations, including, for example evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 4G long-term evolution (LTE) access nodes.

5G networks include a core network utilizing a service based architecture (SBA) and further follow the separation of control plane and user plane functionalities (CUPS). Wireless devices communicating with the base station or access node receive service from the wireless network based on a quality of service (QoS). The QoS required for adequate performance varies based on factors such as the services or applications being used and the particular functionality of the wireless device. In situations where the QoS being received is inadequate for the particular application being utilized, the Third Generation Partnership Project (3GPP) has introduced a feature to temporarily alter or elevate the QoS profile for a wireless device. The feature is a northbound application program interface (API) utilized by the application function (AF) to raise a QoS profile of a particular wireless device or user equipment (UE). The API may be referred to AsSessionWithQoS or simply as “quality on demand”.

Implementation of quality on demand involves a specific 3GPP standard flow between network functions including the policy control function (PCF), network exposure function (NEF), and application function (AF). Deletion of a quality on demand subscription or termination of a quality on demand session also involves a standard flow. However, the standard flow can fail and cause difficulties, for example, when the AF is unreachable due to network failures or other issues. In particular, because the NEF is unable to reach the AF, the NEF becomes out of sync with the PCF, i.e., the NEF retains quality on demand subscriptions that the PCF has already deleted. Thus, the PCF and NEF are not synchronized.

The lack of synchronization between the PCF and the NEF negatively impacts connections and network performance. The IP address associated with the subscription cancelled in the PCF may be reused by the network. However, if the network reassigns the particular IP address to a new subscription, the NEF will not be able to accept the new subscription because old subscription with the same IP address is still in the NEF and NEF cannot create it again.

Accordingly, a solution is needed for overcoming these difficulties. The solution should maintain synchronization between the NEF and the PCF during quality on demand processing.

### OVERVIEW

Exemplary embodiments provided herein include a method for facilitating synchronization between the policy control function (PCF) and the network exposure function (NEF) during quality on demand processing. The method includes receiving, at the NEF, a termination message from the PCF or from an application function (AF) for terminating a subscription uplifting a quality of service (QoS) profile for a wireless device. The process of uplifting may alternatively be described as elevating or raising the QoS profile. The method further includes processing the termination message and deleting the subscription from the NEF upon processing the termination message.

In some instances, the NEF receives the termination message from the PCF and attempts to reach the AF in response to the termination message. In other instances, the NEF receives the termination message from the AF and sends a message to the PCF for deleting application session context.

In a further embodiment, a system for synchronization during quality on demand processing is provided. The system includes a memory storing instructions and data including a subscription uplifting a quality of service (QoS) for a wireless device. The system further includes at least one processor executing the stored instructions to perform multiple operations. The operations include receiving, at a network exposure function (NEF), a termination message from a policy control function (PCF) or from an application function (AF) for terminating the subscription uplifting the quality of service (QoS) profile for a wireless device. The operations additionally include processing the termination message and deleting the subscription from the NEF upon processing the termination message.

In yet a further embodiment, a non-transitory computer readable medium storing instructions executed by a processor to perform multiple operations to achieve synchronization between the PCF and the NEF during quality on demand processing. The operations include receiving, at an NEF, a termination message from a PCF or from an AF for terminating a subscription uplifting a QoS profile for a wireless device. The operations additionally include processing the termination message and deleting the subscription from the NEF upon processing the termination message.

### BRIEF DESCRIPTION OF THE DRAWINGS

FIG. 1 depicts an exemplary environment for a quality on demand synchronization system in accordance with an embodiment.

FIG. 2 depicts a quality on demand synchronization system in accordance with an embodiment.

FIG. 3 depicts a quality on demand synchronization system operating within a core network in accordance with an embodiment.

FIG. 4 depicts an exemplary method for quality on demand synchronization in a network in accordance with an embodiment.

FIG. 5 depicts a further exemplary method for quality on demand synchronization in accordance with an embodiment.

FIG. 6 depicts an exemplary method for quality on demand synchronization in accordance with an embodiment.

FIG. 7 depicts an additional exemplary method for quality on demand synchronization in accordance with an embodiment.

FIG. 8 is a diagram illustrating operation of the quality on demand synchronization system in accordance with an embodiment.

FIG. 9 is a diagram illustrating operation of the quality on demand synchronization system in accordance with an embodiment.

### DETAILED DESCRIPTION

In embodiments disclosed herein, a quality on demand synchronization system ensures that a policy control function (PCF) and network exposure function (NEF) are synchronized during quality on demand processes and in particular during the termination of a quality on demand session or subscription. Embodiments disclosed herein ensure that both the PCF and the NEF delete a quality on demand subscription resultant to a termination request so that neither core component retains the subscription when cancellation has been requested.

Embodiments set forth herein eliminate problems created due to lack of synchronization between the NEF and PCF by ensuring that the NEF always deletes a quality on demand subscription in order to align with the PCF. Providing synchronization eliminates the time-consuming data audit that currently occurs between the NEF and the PCF due to stale subscriptions still contained in the NEF. Embodiments disclosed herein achieve consistent subscription records between the PCF and the NEF. In yet further embodiments, the application function AF can associate a timer with a subscription request, so that the subscription has an expiration time, in order to avoid inconsistency with the NEF.

The quality on demand subscription elevates a QoS profile of the wireless device for enhanced performance. In some situations, the wireless device may require more bandwidth or higher performance than it is receiving. For example, a wireless device may require an elevated QoS profile to execute a successful WebEx® conference. 3GPP provides a standard process both for establishing the quality on demand subscription and terminating the quality on demand subscription or session.

Problems with synchronization can occur during the termination process. With the above example, when the WebEx® conference terminates, the QoS profile elevation through quality on demand processing should also be terminated. When the PCF determines that the quality on demand session context is no longer valid, the PCF deletes the quality on demand session and notifies the NEF through a session termination request. The NEF does not delete the subscription immediately, but sends a subscription deletion request to the AF. If, for some reason, the AF is not reachable from the NEF, the quality on demand subscription remains in the NEF database but is no longer contained in the PCF. This leaves the NEF with more active subscriptions than the PCF. Because the PCF has terminated the subscription, the wireless network reuses the IP address utilized for the subscription by assigning the IP address to a new subscription. However, the NEF will not be able to accept the new subscription because the original subscription still exists in the NEF. This impacts the connection for the wireless device requesting the new subscription.

Further, the problem is exacerbated because in order to delete the subscription at the NEF after the lapse in communication, ongoing communication is required with the PCF. However, because the PCF has already deleted the subscription and has no record of the subscription, the deletion of the subscription at the NEF is delayed.

In embodiments described herein, the NEF deletes the quality on demand subscription whether AF is reachable or not. This is in contrast to the currently utilized standard, in which the NEF is required to wait for a response from the AF prior to deletion of a subscription and therefore does not delete the quality on demand subscription when it is unable to reach the AF. Thus, in the currently existing scenario, the NEF maintains more active subscriptions than the PCF and the two are not synchronized. In the proposed scenario, the PCF and NEF have the same number of subscriptions and are synchronized. Further, solutions proposed herein include a subscription expiration time created by the AF to further ensure synchronization.

In addition to the systems and methods described herein, non-transitory computer-readable mediums may store the operations for the instructions or methods. Further, processing nodes on the network may execute the instructions or methods. The processing node may include a processor included in the NEF, the AF, and/or the PCF or a processor included in any controller node in the wireless network.

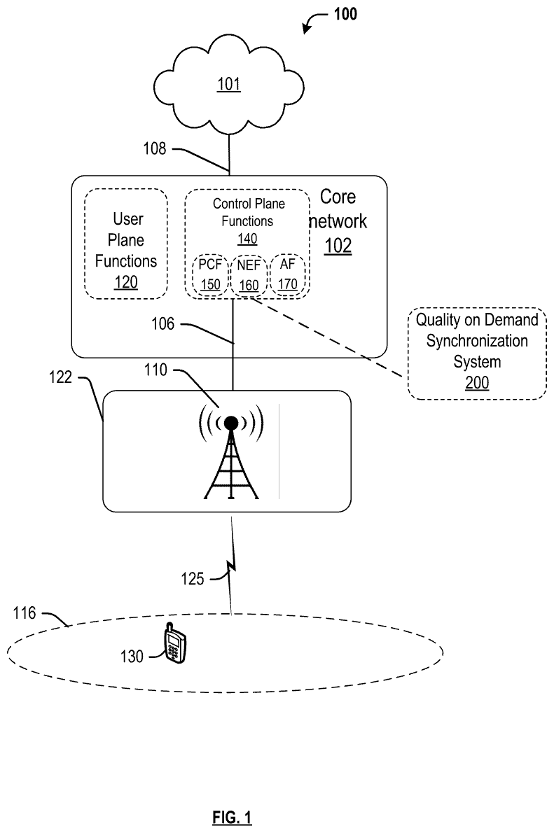

FIG. 1 depicts an exemplary environment 100 for implementing a quality on demand synchronization system 200. Environment 100 comprises a communication network 101, core network 102, and a radio access network (RAN) 122 including at least an access node 110. Wireless device 130 is located in a coverage area 116 and communicates with the access node 110 over communication link 125. Although only one wireless device 130 is shown, it should be understood that any number of wireless devices could be included. Further, the quality on demand synchronization system 200 interacts with the core network 102 to monitor synchronization between components of the core network 102, or more specifically control plane functions 140 including at least an NEF 160, a PCF150, and an AF 170.

The PCF 150 is a functional element for policy control decisions. Among other functions, the PCF 150 provides policy rules for application and service data flow detection, gating, and QoS processing. The NEF 160 is responsible for managing the external open network data, and external applications that want to access the internal data of the core network 102 must pass through the NEF 160. The NEF 160 securely exposes services and features of the core network 102. Furthermore, components not shown may include, for example, additional core network functions, gateway node(s) controller nodes, and additional access nodes. The AF 170 exposes the application layer for interaction with network functions and resources and provides application services to subscribers. Subscribers may be or include external entities.

The quality on demand synchronization system 200 is illustrated as communicating with or incorporated in the core network 102. In some embodiments, the quality on demand synchronization system 200 may be incorporated in the NEF 160. The core network 102 may be structured using a service based architecture (SBA) utilizing core network functions and elements including user plane functions (UPFs) 120 and control plane functions 140. The control plane functions 140 include at least the PCF 150 and NEF 160 may further include the additional components described herein.

In an SBA architecture, service-based interfaces may be utilized between control plane functions 140, while multiple UPFs 120 connect over point-to-point link. The UPF 120 accesses a data network, such as network 101, and performs operations such as packet routing and forwarding, packet inspection, policy enforcement for the user plane, quality of service (QoS) handling, etc. In addition to the PCF 150 and the NEF 160, the control plane functions may include, for example, a network slice selection function (NSSF), a network repository function (NRF), a unified data management (UDM) function, an access and mobility function (AMF), an authentication server function (AUSF), binding support function (BSF) and a session management function (SMF). Additional or fewer control plane functions may also be included. The AMF receives connection and session related information from the wireless device 130 and is responsible for handling connection and mobility management tasks. The SMF is primarily responsible for creating, updating and removing sessions and managing session context. The UDM function provides services to other core functions, such as the AMF, SMF, and NEF. The UDM may function as a stateful message store, holding information in local memory. The NSSF can be used by the AMF to assist with the selection of network slice instances that will serve a particular device.

The RAN 122 can include various access network functions and devices disposed between the core network 102 and the end-user wireless device 130. For example, the RAN 122 includes at least an access node (or base station), such as an eNodeB and/or a next generation NodeB (gNodeB) 110 communicating with a plurality of end-user wireless device 130. Further, either of core network 102 and radio access network 122 can include one or more of a local area network, a wide area network, and an internetwork (including the Internet) and capable of communicating signals and carrying data, for example, to support voice, push-to-talk, broadcast video, and data communications by end-user wireless device 130.

Access node 110 can be any network node configured to provide communication between end-user wireless device 130 and communication network 101, including standard access nodes and/or short range, low power, small access nodes. For instance, access node 110 may include any standard access node, such as a macrocell access node, base transceiver station, or a radio base station, or the like. In embodiments further discussed herein, the access node 110 is a next generation NodeB (gNB). However, the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless device 130 are illustrated in FIG. 1, any number of access nodes and wireless devices can be implemented within environment 100.

As further described herein, by utilizing antennas, access node 110 can deploy a wireless air interface 125 using one or more frequency bands over one or more coverage areas 116. Further, the different sets of antennas can be used to implement various transmission modes or operating modes in each sector, including but not limited to multiple in multiple out (MIMO), carrier aggregation (including inter-band and intra-band carrier aggregation), and different duplexing modes including frequency division duplexing (FDD) and time division duplexing (TDD).

Wireless device 130 may be any device, system, combination of devices, or other such communication platform capable of communicating wirelessly with access node 110 using one or more frequency bands deployed therefrom. Wireless device 130 may be, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110. The FWA devices may include, for example, customer premises equipment (CPE). Additionally, wireless devices have evolved to include Internet of things (IoT) devices, which describes the network of physical objects or things that are embedded with sensors, software, and other technologies for the purpose of connecting and exchanging data with other devices and systems over the Internet. As set forth above, the wireless device 130 may utilize different applications at different times, which may cause them to be assigned to different network slices or receive a different QoS. The wireless device 130 can be end-user wireless devices (e.g., user equipment (UEs)) utilizing communication links 125, which may operate based on 6G, 5G new radio (NR), 4G long term evolution (LTE), or any other suitable type of ratio access technology (RAT).

Communication Network 101 Can Be a Wired And/or Wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless device 130. Wireless network protocols can comprise multimedia broadcast multicast services (MBMS), code division multiple access (CDMA) single-Carrier radio transmission technology(1xRTT), Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path—including combinations thereof. Communication link 106 can be wired or wireless and use various communication protocols such as Internet, Internet protocol (IP), local-area network (LAN), optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol as described herein. Communication link 106 can be a direct link or might include various equipment, intermediate components, systems, and networks. Communication links 106 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

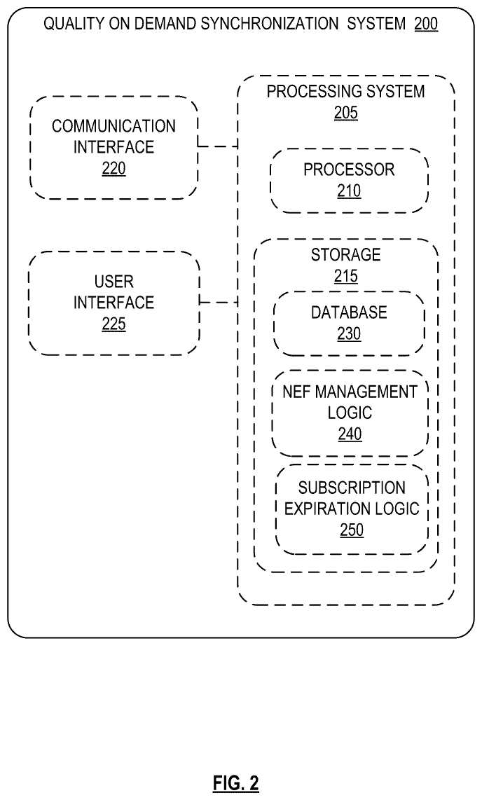

FIG. 2 illustrates a quality on demand synchronization system 200 in accordance with embodiments described herein. The components described herein are merely exemplary as many different configurations for the quality on demand synchronization system 200 may be implemented. The quality on demand synchronization system 200 may be configured to perform the methods and operations disclosed herein to dynamically ensure that the NEF 160 and the PCF 150 remain synchronized with respect to quality on demand subscriptions. In the disclosed embodiments, the quality on demand synchronization system 200 may be integrated with the core network 102, for example with the NEF 160, or may be an entirely separate component capable of communicating with at least the NEF 160 of the core network. Further, the components of the quality on demand synchronization system 200 may be distributed so that one or more components are located within the PCF150, the NEF 160, the AF 170, and/or a separate processing node in communication with or integrated with the core network 102.

The quality on demand synchronization system 200 may be configured for performing the operations described herein during termination of a quality on demand subscription or session utilizing a processing system 205. Processing system 205 may include a processor 210 and a storage device 215. Storage device 215 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein.

For example, NEF management logic 240 may ensure that the NEF 160 deletes a quality on demand subscription upon receiving a request, for example from the PCF 150, regardless of whether the NEF 160 is able to reach the AF 170. Subscription expiration logic 250 may be utilized by and/or incorporated in the AF 170 to ensure that quality on demand subscriptions expire and that the NEF 160 will be aware of the expiration. Further, the storage area 260 may include a database 230. The database 230 may store active quality on demand subscriptions. To perform the above-described operations, the NEF management logic 240 and the subscription expiration logic 250 may be executed by the processor 210 to operate on the database 230 to manage quality on demand subscriptions and thus also synchronization between the NEF 160 and the PCF 150.

Processor 210 may be a microprocessor and may include hardware circuitry and/or embedded codes configured to retrieve and execute software stored in storage device 215. The quality on demand synchronization system 200 further includes a communication interface 220 and a user interface 225. Communication interface 220 may be configured to enable the processing system 205 to communicate with other components, nodes, or devices in the wireless network.

Communication interface 220 may include hardware components, such as network communication ports, devices, routers, wires, antenna, transceivers, etc. User interface 225 may be configured to allow a user to provide input to the quality on demand synchronization management system 200 and receive data or information from other system components. User interface 225 may include hardware components, such as touch screens, buttons, displays, speakers, etc. The quality on demand synchronization system 200 may further include other components such as a power management unit, a control interface unit, etc.

The location of the quality on demand synchronization system 200 may depend upon the network architecture. As set forth above, the quality on demand synchronization system 200 may be located in the core network 102, in a separate processing node, in the NEF 160, in multiple locations such as the PCF 150, NEF 160, and/or AF 170, or may be an entirely discrete component. Further, although shown as a single integrated system, the functions of NEF management and subscription expiration may be separated and be disposed in separate locations. For example, the NEF management logic 240 may be disposed in the NEF 160 and the subscription expiration logic 250 may be disposed in the AF 170.

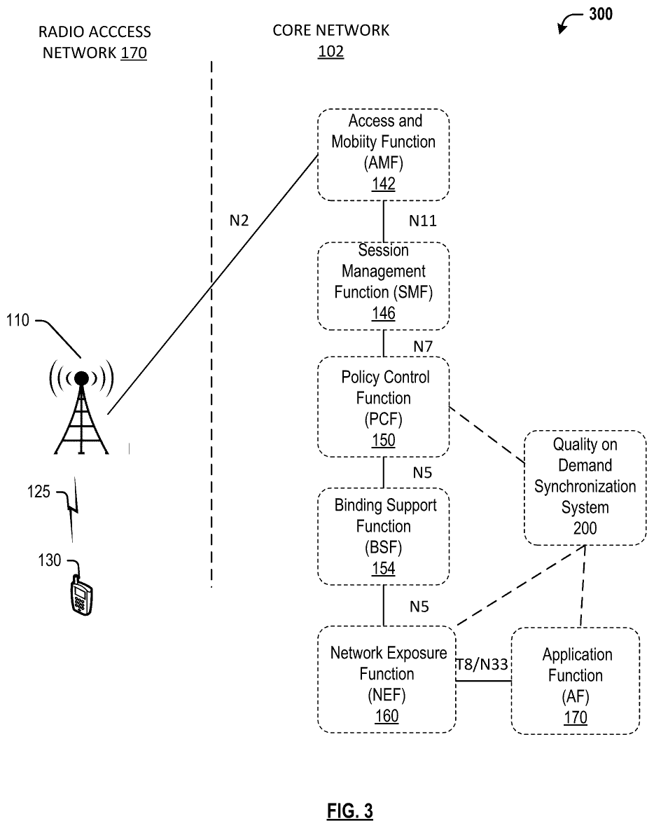

FIG. 3 depicts an environment 300 showing a quality on demand synchronization system 200 communicating with network functions within the core network 102 in accordance with an embodiment. FIG. 3 additionally illustrates the wireless device 130 communicating with the access node 110 over the wireless communication link 125. The access node 110 communicates with the control plane functions of the core network 102 by communicating with an AMF 142 over an N2 interface.

Within the control plane 140 of the core network 102, multiple network functions communicate with one another to establish and terminate quality on demand subscriptions. Within the control plane 140, an AMF 142, an SMF 146, PCF 150, a binding support function (BSF) 154, NEF 160, and AF 170 are illustrated. These components communicate over the illustrated interfaces. For example, the AMF 142 can receive connection requests over interface N2 from one or more wireless devices via access node 110, and manage tasks associated with connection or mobility management, while forwarding session management requirements over an N11 interface to the SMF 146. Meanwhile, the SMF 146 communicates over an N7 interface with the PCF 150. The BSF 154 functions as a proxy between the PCF 150 and NEF 160, communicating using an N5 interface.

The AF 170 plays a key role in traffic management and QoS assignments, through interaction with the NEF 160. The AF 170 accesses the NEF 160 for retrieving resources and interacts with the PCF 150 to enable policy control. The AF 170 further provides application services to subscribers. The AF 170 also provides the application function exposure service that allows network function service consumers to subscribe to, modify, and unsubscribe from application events, and notifies service consumers with a corresponding subscription about observed events on the AF 170. The NEF 160 communicates with the AF 170 over a T8 reference point that was introduced for northbound application programming. Further, the N33 interface exposes APIs that enable applications to update parameters.

As illustrated, the quality on demand synchronization system 200 may be incorporated in or communicate with the PCF 150, the NEF 160, and/or the AF 170. Further, the quality on demand synchronization system 200 may operate as a processing node in communication with the NEF 160, PCF 150, and/or AF 170 in order to trigger these network functions to perform the operations described herein.

All of the illustrated network functions can include a processor, a memory, and may be configured to perform the various functions described herein. Further, each network function can associate with different reference points, including reference points for data transmission between different network nodes and reference points for control signal transmission between different network nodes.

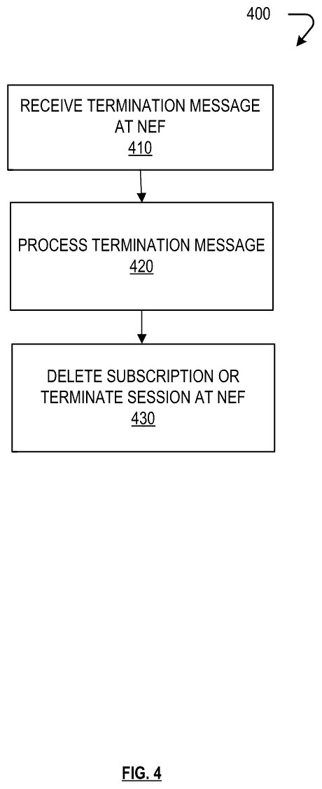

FIG. 4 illustrates a generalized exemplary method 400 for quality on demand synchronization between the PCF 150 and the NEF 160. Method 400 may be performed by any suitable processor discussed herein, for example, a processor 210 included in the quality on demand synchronization system 200, or a processor in an NEF 160. For discussion purposes, as an example, method 400 is described as being performed by the processor 210 of the quality on demand synchronization system 200. However, it should be understood that the steps illustrated in FIG. 4 are performed in conjunction with the NEF 160 and the processor 210 may in fact, be incorporated in the NEF 160.

Method 400 starts in step 410, in which the processor 210 receives a termination message delivered to the NEF 160. The termination message may, for example, be transmitted from the PCF 150 or from the AF 170 and may be or include a request to terminate a quality on demand session or subscription.

In step 420, the processor 210 processes the termination message. When the termination message is received from the PCF 150, the processor 210 causes a session termination notification to be sent to the AF 170. However, when the termination message is received from the AF 170, the processor 210 triggers an authorization to delete the subscription to be transmitted from the NEF 160 to the PCF 150.

In step 430, the processor 210 triggers deletion of the subscription and termination of the session from the NEF 160. The deletion of the subscription occurs regardless of whether the NEF 160 receives a response from the AF 170 or the PCF 150.

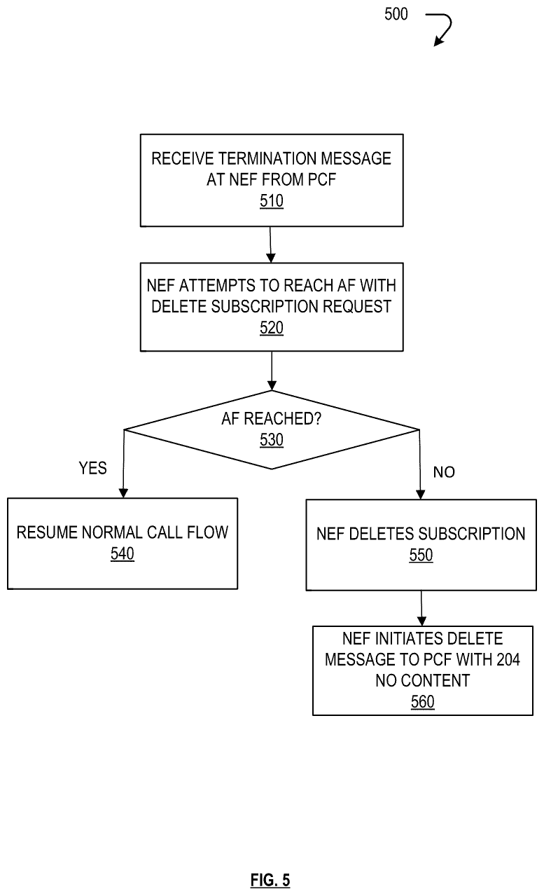

FIG. 5 depicts a further exemplary method 500 for quality on demand synchronization in accordance with an embodiment. Method 500 may be performed by any suitable processor discussed herein, for example, the processor 210 included in the quality on demand synchronization system 200 or in the NEF 160. For discussion purposes, as an example, method 500 is described as being performed by the processor 210 included in the quality on demand synchronization system 200, which may be wholly or partially incorporated in the NEF 160.

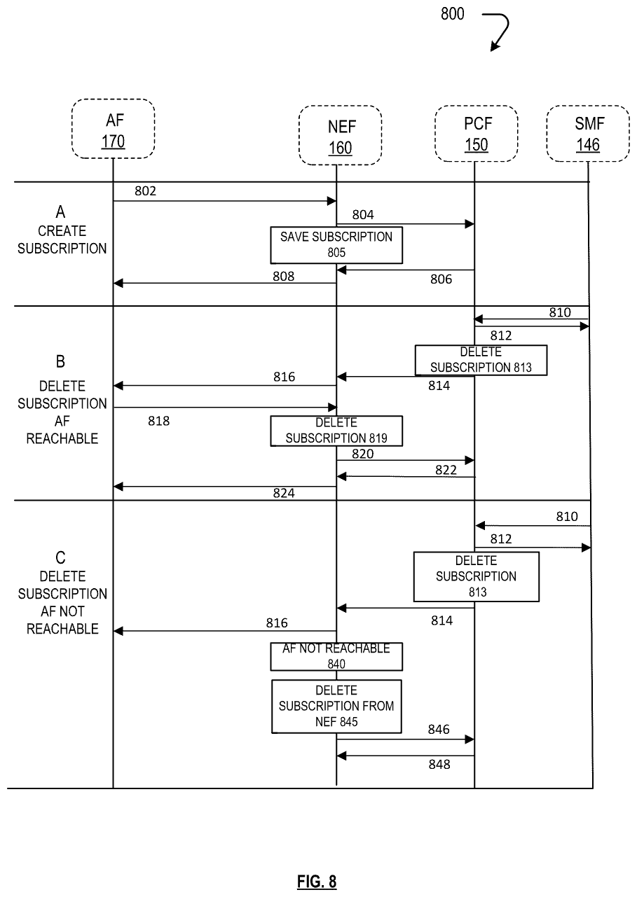

Method 500 starts in step 510, in which the NEF 160 receives a termination message from the PCF 150 for terminating a quality on demand subscription. In step 520, in response to the termination message, the NEF 160 attempts to reach the AF 170 with a subscription termination request. In step 530, the processor 210 determines if the AF 170 has been reached by the NEF 160. If the AF has been reached in step 530, the processor 210 allows normal call flow operations in step 540. This normal call flow is further described below with respect to FIG. 8 in steps 820-824. However, if the AF 170 has not been reached, the processor 210 triggers a modified call flow. The modified call flow triggers deletion of the quality on demand subscription from the NEF 160 in step 550. Finally, in step 560, the NEF 160 initiates a delete message to the PCF including a 204 no content status response message. Further discussion of the modified call flow is contained below with respect to FIG. 8.

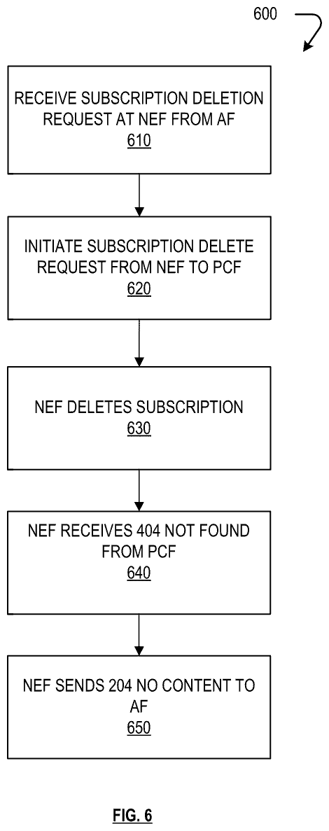

FIG. 6 depicts an additional exemplary method 600 for quality on demand synchronization in accordance with an embodiment. Method 600 may be performed by any suitable processor discussed herein, for example, the processor 210 in the quality on demand synchronization system 200, which may be wholly or partially incorporated in the NEF 160. For discussion purposes, as an example, method 600 is described as being performed by the processor 210 included in the quality on demand synchronization system 200.

In step 610, the NEF 160 receives a subscription deletion request from the AF 170. The request may be or include, for example, an AsSessionWithQoS API request for subscription deletion. In step 620, the NEF 160 initiates a subscription delete request to the PCF 150. The request may be or include, for example, an Npcf_PolicyAuthorization API Delete.

In step 630, the NEF 160 deletes the subscription from its database. In step 640, the NEF 160 receives a 404 not found status response message from the PCF 150. Finally, in step 650, the NEF 160 sends a 204 no content status response message to the AF 170. Through this process, both the PCF 150 and the NEF 160 delete the subscription request and are synchronized.

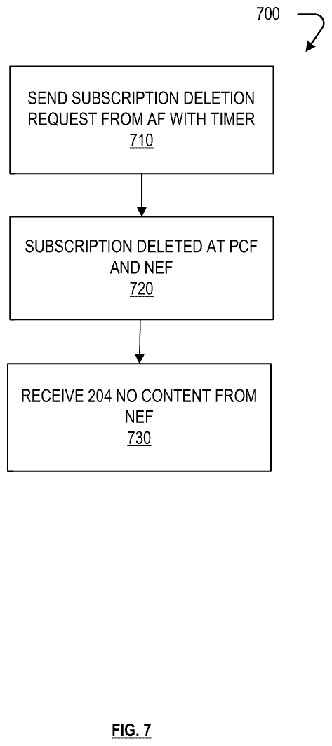

FIG. 7 depicts an additional exemplary method 700 for quality on demand synchronization. Method 700 may be performed by any suitable processor discussed herein, for example, a processor 210 included in the synchronization management system 200, which may be wholly or partially incorporated in the AF 170. For discussion purposes, as an example, method 700 is described as being performed by the processor 210.

In step 710, the processor 210 appends a timer to a subscription deletion request and triggers sending of the request with the associated timer. The timer may be set based on the length of the event requiring QoS profile elevation. For example, if a WebEx® is scheduled to last for two hours, the timer may be set to two hours or slightly longer to ensure that the quality of service is sufficient for the Webex.

In step 720, the session is terminated at the PCF 150 and NEF 160 at the expiration of the timer. This step may be performed by processors in the PCF 150 and NEF 160 in response to the received timer. In step 730, the processor 210 at the AF 170 receives a 204 no content status response message from the NEF 160.

Accordingly, as set forth above, embodiments provide for quality on demand synchronization in order to ensure that the PCF 150 is synchronized with NEF 160. It should be noted that multiple PCFs 150 may be synchronized with the NEF 160. In some embodiments, methods 400, 500, 600, and 700 may include additional steps or operations. Furthermore, the methods may include steps shown in each of the other methods. Additionally, the order of steps shown is merely exemplary and the steps may be re-ordered as appropriate. As one of ordinary skill in the art would understand, the methods 400, 500, 600, and 700 may be integrated in any useful manner.

FIG. 8 is a diagram 800 illustrating operation of the quality on demand synchronization system 200 in accordance with an embodiment. As explained above, the quality on demand synchronization system 200 may be a discrete node operating in conjunction with the NEF 160, AF, 170 and/or PCF 150. The quality on demand synchronization system 200 may be partially or wholly incorporated in any of these components. In one embodiment, NEF management logic 240 is incorporated in the NEF 160 and subscription expiration logic 250 is incorporated in the AF 170. the SMF 146 and/or UPF 120.

FIG. 8 illustrates interaction between the components of the core network 102 during quality on demand processing. Section A illustrates creation of a quality on demand subscription. In step 802, the AF 170 sends a request for quality on demand services, for example, an AsSessionWithQoS API request for QoS modification to the NEF 160 over the T8 interface.

In step 804, the NEF 160 initiates a request to the PCF 150, which may be a Npcf_PolicyAuthorization API request. Further, the NEF 160 saves the subscription in its database 230 step 805. In response to the request received from the NEF 160, the PCF 150 sends a 201 created request to the NEF 160 in step 806. The NEF then sends a 201 created message to the AF 170 in step 808. Thus the subscription for quality on demand services is created in part A.

Part B illustrates a normal notification flow for session termination. In step 810, the SMF 146 sends a session termination request to the PCF 150 over the N7 interface. This request may be a PolicyUpdateNotify Request terminate. In response, in step 812, the PCF 150 sends a response over the N7 interface to the SMF 146, which may be a PolicyUpdateNotify Response. Further, the PCF 150 will delete the subscription upon receiving the message. Thus the PCF 150 deletes the subscription from its database in step 813. The PCF 150 sends a notification to the NEF 160, e. g, a protocol data unit (PDU) Session Terminate over the N5 interface in step 814. Upon receiving the termination notification, the NEF 160 sends a session termination notification to the AF 170 in step 816 over the N33 interface. In response, the AF 170 sends a delete subscription request to the NEF 160 in step 818.

Because, in this instance of the normal notification flow, the NEF 160 was able to reach the AF 170 for subscription deletion, steps 820-824 proceed as normal. Steps 820-824 are illustrative of the normal call flow referenced above with respect to FIG. 5. That is, upon receiving the delete subscription request in step 818, the NEF160 deletes the subscription in step 819 and initiates an Npcf_PolicyAuthorizationDelete message to the PCF150 over the N5 interface in step 820. In step 822, the PCF 150 notifies the NEF 160 of subscription deletion over the N5 interface and responds with a 204 no content status response message. The NEF 160 sends the AF 170 a 204 no content status response message in step 824 over the N33 interface.

Part C illustrates a modified flow achieved by the quality on demand synchronization system 200 when the AF 170 is not reachable. Steps 810-816 are the same as those described above with respect to part B. However, when the NEF 160 sends a session termination notification to the AF 170 in step 816, it finds that the AF 170 is unreachable and no response is received at step 840. Thus, the quality on demand synchronization system 200 triggers deletion of the quality on demand subscription from the NEF database 230 in step 845. In step 846, the NEF initiations a Npcf_PolicyAuthorization Delete message to the PCF 150, which is a 204 no content status response message. Finally, in step 848, the PCF 150 returns a 404 not found status response message to the NEF 160 as the subscription has already been deleted from the PCF 150.

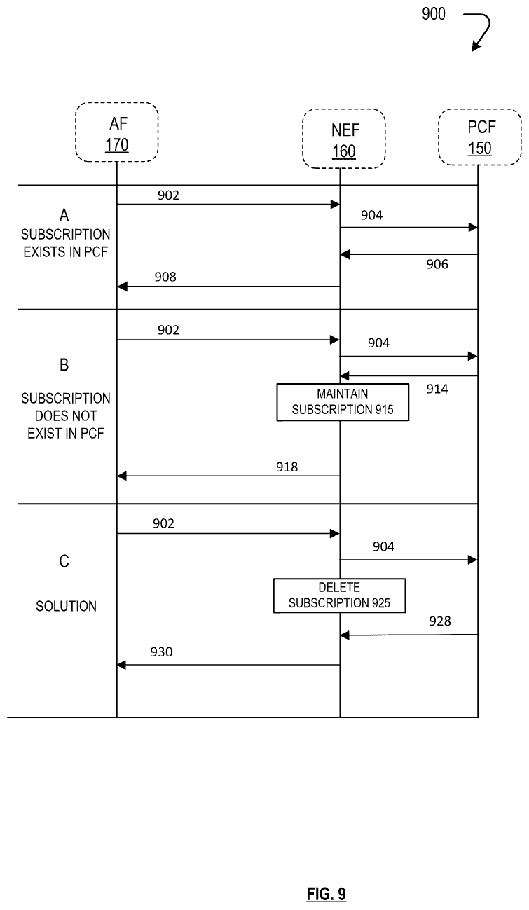

FIG. 9 illustrates a scenario 900 involving interaction between the components of the core network 102 in a further example when the AF 170 sends the subscription deletion request to the NEF 160. The existing procedures differ based on whether the subscription exists in the PCF 150.

Section A illustrates the call flow when the AF 170 requests subscription deletion and the subscription exists in the PCF 150 in accordance with the normal call flow. In step 902, the AF 170 sends a subscription deletion request over the T8 interface to the NEF 160, e.g. and AsSessionWithQoS API request. In step 904, the NEF 160 sends a deletion request, e.g., a Npcf_PolicyAuthorization API delete request to the PCF 150. The PCF 150 returns a 204 no content status response message to the NEF 160 in step 906. The NEF 160 then forwards a 204 no content status response message to the AF 170 in step 908.

In contrast, Section B illustrates the scenario in which the subscription does not exist in the PCF 150, due to lack of synchronization between the PCF 150 and the NEF 160. Steps 902 and 904 are the same as described above, such that the AF 170 sends the delete request to the NEF 160, which notifies the PCF 150. However, the PCF 150 does not have the subscription and therefore sends a 404 not found status response message to the NEF 160 in step 914. As a result, in step 915, the NEF 160 maintains the subscription and returns a 404 not found message to the AF 170 in step 918. Thus, the AF 170 is unable to delete the subscription since the NEF 160 maintains the subscription and the PCF 150 no longer is aware of the subscription.

Part C illustrates a solution for avoiding the scenario illustrated in Part B. Steps 902 and 904 are the same as described above, such that the AF 170 sends the delete request to the NEF 160, which notifies the PCF 150. However, In step 925, NEF 160 deletes the subscription from its database. The NEF 160 then receives a 404 not found status response message from the PCF 150 in step 928, since the PCF 150 no longer has the subscription. However, in step 930, the NEF 160 sends a 204 no content message to the AF 170, which confirms deletion of the subscription.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
receiving, at a network exposure function (NEF), a termination message from a policy control function (PCF) or from an application function (AF) for terminating a subscription uplifting a quality of service (QoS) profile for a wireless device;
processing the termination message; and
deleting the subscription from the NEF upon processing the termination message.

2. The method of claim 1, wherein the NEF receives the termination message from the PCF.

3. The method of claim 2, further comprising attempting to reach the AF from the NEF upon processing the termination message.

4. The method of claim 2, further comprising sending from the NEF a message to the PCF including 204 no content status response code upon deleting the subscription.

5. The method of claim 4, wherein the message is a Npcf_PolicyAuthorization_Delete message for deleting an application session context.

6. The method of claim 1, wherein the NEF receives the termination message from the AF.

7. The method of claim 6, further comprising sending from the NEF, a Npcf_PolicyAuthorization_Delete message to the PCF for deleting an application session context.

8. The method of claim 6, further comprising, receiving at the NEF, from the PCF, a 404 not found status response code.

9. The method of claim 7, further comprising sending from the NEF to the AF a 204 no content status response code.

10. The method of claim 6, further comprising receiving a subscription request from the AF including a timer.

11. A system comprising:
a memory storing instructions and data including a subscription uplifting a quality of service for a wireless device; and
at least one processor executing the stored instructions to perform operations including;
receiving, at a network exposure function (NEF), a termination message from a policy control function (PCF) or from an application function (AF) for terminating the subscription uplifting the quality of service (QoS) profile for a wireless device, the subscription initiated by the AF;
processing the termination message; and
deleting the subscription from the NEF upon processing the termination message.

12. The system of claim 11, wherein the NEF receives the termination message from the PCF.

13. The system of claim 12, the operations further comprising attempting to reach the AF from the NEF upon processing the termination message.

14. The system of claim 12, the operations further comprising sending from the NEF a message to the PCF including 204 no content status response code.

15. The system of claim 14, wherein the message is a Npcf_PolicyAuthorization_Delete message for deleting an application session context.

16. The system of claim 11, wherein the NEF receives the termination message from the AF.

17. The system of claim 16, the operations further comprising, sending from the NEF, a Npcf_PolicyAuthorization_Delete message to the PCF for deleting an application session context.

18. A non-transitory computer readable medium storing instructions executed by a processor to perform operations comprising:
receiving, at a network exposure function (NEF), a termination message from a policy control function (PCF) or from an application function (AF) for terminating a subscription uplifting a quality of service (QoS) profile for a wireless device, the subscription initiated by the AF;
processing the termination message; and
deleting the subscription from the NEF upon processing the termination message.

19. The method of claim 1, wherein the NEF receives the termination message from the PCF and the operations further comprise sending from the NEF a message to the PCF including 204 no content upon deleting the subscription.

20. The method of claim 1, wherein the NEF receives the termination message from the AF and the operations further comprise sending from the NEF, a Npcf_PolicyAuthorization_Delete message to the PCF for deleting an application session context.
